(19) United States
(12) Patent Application Publication
(10) Pub. No.: US 2011/0083020 A1
(43) Pub. Date: Apr. 7, 2011

(54) SECURING A SMART CARD

(75) Inventors: Wilhelmus P.A.J. Michiels, Eindhoven (NL); Christiaan Kuipers, Eindhoven (NL)

(73) Assignee: Irdeto Access B.V., HOFFDDORP (NL)

(21) Appl. No.: 12/865,671

(22) PCT Filed: Jan. 26, 2009
(86) PCT No.: PCT/IB2009/050303

§ 371 Date: Dec. 6, 2010

(30) Foreign Application Priority Data
Jan. 31, 2008 (EP) 08150860.8

(51) Int. Cl. G06F 12/14

(52) U.S. Cl. 713/189

(57) ABSTRACT

The invention provides a method for securing a smart card (100), the smart card comprising processing means (101), a memory (110) for storing in an encrypted fashion a software module (115) to be executed by the processing means, and a decryption means (130) configured for just-in-time decryption of the software module, the method comprising the step of providing the smart card with a white-box implementation of the decryption means. In one embodiment the white-box implementation comprises a white-box implementation of the Lombok cryptographic algorithm.

### FIELD OF THE INVENTION

The invention relates to a smart card and to a method for securing such a smart card.

### BACKGROUND OF THE INVENTION

A smart card, microprocessor card, chip card, or integrated circuit card (ICC) is defined as a relatively small, usually pocket-sized card with embedded integrated circuits which can process information. Such smart cards are used to securely store sensitive information such as cryptographic keys or software routines that implement valuable algorithms or know-how.

Because of their closed nature, smart cards were long regarded as black boxes where an attacker could only observe input and output but not the operations of the implementation of a cryptographic algorithm. Today however many techniques exist to obtain details of such an implementation, and sometimes even to extract all or part of the embedded software from the card. Some well-known examples are fault injection attacks and buffer overflow attacks.

In a fault injection attack on a smart card, an attacker tries to change the behavior of the smart card by giving it invalid input or by exposing it to out-of-specification conditions, such as extreme voltage. A fault injection attack can also be done in an invasive way. An example of an invasive fault injection is that a chip is physically opened and the unprotected hardware is exposed to radiation by which the chip's behavior is changed. The changed behavior due to such intentionally-caused faults may reveal some of the sensitive information.

In a buffer overflow attack an attacker fills a memory location with more data than can be stored, which causes other data structures to become corrupted. With the right choice of data, the corruption can result in the leakage of a data or code fragment from memory to the outside world.

See e.g. Oliver Kömmerling, Markus G. Kuhn, ‘Design Principles for Tamper-Resistant Smartcard Processors’, Proceedings of the USENIX Workshop on Smartcard Technology (Smartcard '99), Chicago, Ill., USA, May 10-11, 1999, USENIX Association, pp. 9-20, ISBN 1-880446-34-0 for a general introduction to these kinds of attacks.

To protect against these kinds of attacks, WO2007105126 (attorney docket PH005600) and US patent application 20060140401 propose to employ a white-box implementation to protect cryptographic implementations and mention that this solution can be used among other devices in smart cards. White-box implementations of cryptographic algorithms are implementations that hide some or all of the inner workings of a cryptographic algorithm against a white-box attack, i.e., an attack in which an attacker can observe some or all of the instructions executed by the processor. In some cases, the attacker has some form of control over the operating environment, which allows him to observe at least part of the cryptographic operations and identify at least part of the cryptographic key used in the algorithm during execution. For example he can execute the implementation inside a debugging environment or virtual machine and thereby observe all operations, manipulate data buffers and monitor the execution flow.

In other cases, the attacker can cause the operating environment to ‘leak’ or divulge part of the implementation or part of the contents of data buffers during execution of the cryptographic algorithm. For example, he may be able to use a buffer overflow attack to extract parts of the cryptographic implementation. If the right part is extracted, he may thereby learn the cryptographic key or particular settings in the implementation that allow him to undo some or all of the cryptographic protection.

White-box implementations hide some or all of the inner workings of a cryptographic algorithm, in particular the key data. This can be done in a variety of ways. A popular technique for creating white-box implementations is using a combination of encoding tables in the cryptographic algorithm with random bijections representing compositions rather than individual steps. The decryption key and the decryption algorithm are effectively turned into one monolithic block. No single part of this block reveals any information about the inner workings of the algorithm or the key. In fact even when given the entire white-box implementation it is extremely difficult to reverse engineer the original algorithm or the decryption key used. Another technique, disclosed in e.g. European patent application serial number 08155798.5 (attorney docket PH010099) is obfuscation of an exponent in cryptographic algorithms such as RSA.

A disadvantage of using a white-box implementation of a cryptographic algorithm on a smart card is that white-box implementations may grow to be extremely large in code size compared to traditional implementations, while smart cards have very limited storage. For instance, the white-box implementation of the AES encryption algorithm as proposed by Chow 1 (as cited below) has a size of more than 0.7 megabytes. One reference implementation of AES in traditional, i.e. non white-box, form is in the order of 10 kilobytes in size.

### SUMMARY OF THE INVENTION

It is an object of the invention to efficiently secure a smart card against attacks that expose information about the workings of a software module in the smart card.

The invention achieves this object with a method as claimed in claim 1 and a smart card as claimed in claim 5. The software module that needs to be protected is encrypted using any suitable cryptographic algorithm. For example 3DES or AES could be used. A just-in-time decryption module is provided, which decrypts the software module (or the required parts thereof) when this module needs to be executed. The decrypted copy of the module is deleted as soon as possible afterwards. This reduces the chance of an attacker obtaining a copy of the software module. He may be able to extract the encrypted version of this module, but this version is useless without the right decryption key.

According to the invention, a white-box implementation of the decryption module is used. Because only this relatively small module is implemented using white-box techniques, the storage needs for the smart card increase only slightly. The above-mentioned techniques for creating such a white-box implementation can be used, although other white-box techniques known now or devised hereafter may also be used.

The main requirement is that the white-box implementation is not too small in size and has the property that if an attacker has any part of the implementation (including the key used by the algorithm), then it is difficult for him to derive from this a functionally correct decryption function. This requirement is weaker than what is often assumed in white-box implementations, namely that the attacker has complete control over the environment. The present invention thus permits a trade-off of white-box security against key-size.

A necessary condition for the implementation of the decryption algorithm is that this is done in such a way that from a part of the implementation an attacker cannot derive the underlying key. Some white-box techniques, for example the above-mentioned usages of a combination of encoding tables, are designed to withstand white-box attacks where the attacker has complete control over the environment. While such techniques are suitable for the purposes of the present invention, there are other, easier white-box techniques that are also suitable for the present invention.

As an example, when creating a white-box implementation of AES it suffices to encode the input and output of each lookup table by a non-linear encoding. By encoding the output of the lookup tables that precede a XOR operation by linear encodings (and, correspondingly, also the inputs of the lookup tables that follow the XOR operation), it is not necessary for the purpose of the present invention to implement the XOR operation by a lookup table.

An additional advantage is that now the software that needs to be protected is isolated more, which means it can be intensively reviewed to protect it from the abovementioned attacks.

Hence, during the execution of this presumably sensitive code, the chances of a successful attack significantly decrease. While other software may still be susceptible to attacks, at best this will expose encrypted parts of the protected software module. The attacker will be unable to make use of these parts.

Preferably the white-box implementation is a white-box implementation of the Lombok cryptographic algorithm as disclosed in U.S. Pat. No. 7,043,016 (attorney docket PHNL000365) and EP1307993B1 (attorney docket PHNL000444). An advantage of this embodiment is that a white-box implementation of Lombok is smaller than a white-box implementation of AES. This is due to the fact that Lombok has 4-bit S-boxes, i.e. S-boxes that map 4 bits to 4 bits, while AES has 8-bit S-boxes.

For each S-box, the white-box Lombok and AES implementations have a lookup table that contains it. An m-bit S-box results in a lookup table with 2^{m} rows. Hence, smaller S-boxes result in smaller white-box implementations.

### BRIEF DESCRIPTION OF THE DRAWING

These and other aspects of the invention will be apparent from and elucidated with reference to the illustrative embodiments shown in the drawings, in which:

FIG. 1 schematically shows a smart card.

### DETAILED DESCRIPTION OF THE INVENTION

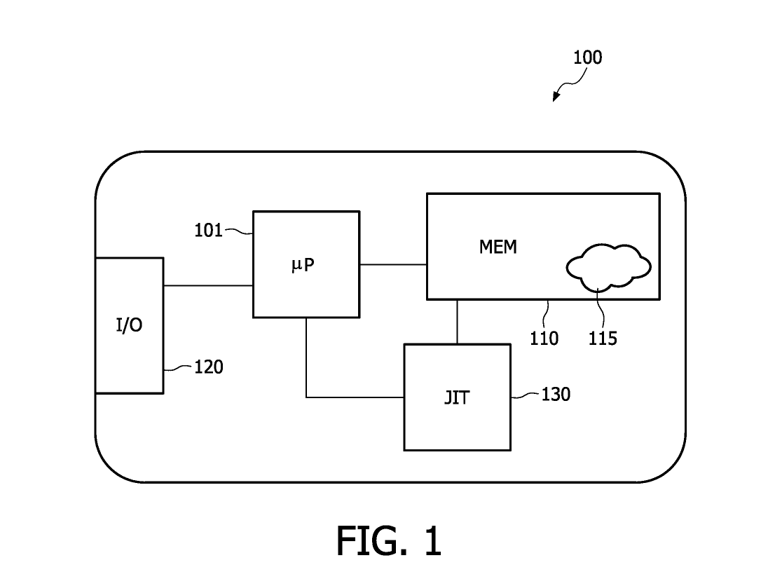

FIG. 1 schematically shows a smart card 100 comprising a processor 101 and a memory 110 for storing one or more software module(s) to be executed by the processor 101. One software module is module 115, which is the subject of the present invention. The memory 110 is preferably implemented as an EEPROM or flash memory, although many alternative storage media are available. The memory 110 may additionally store data such as cryptographic keys or authorization elements. A separate memory (not shown) could also be used to store such data, for instance if separation of instructions and data is desired.

The smart card 100 also comprises input/output module 120 for receiving and transmitting data from and to a device (not shown) to which the smart card 100 is coupled. This module 120 is usually embodied as a chip that makes contact with electrical connectors in a reader in the device, preferably as defined in the ISO/IEC 7816 and ISO/IEC 7810 series of standards. An alternative is used in so-called contactless smart cards, where the transmission of data is through radio frequency induction technology, e.g. as defined in ISO/IEC 14443.

The smart card 100 can for instance be used in a conditional access or DRM system and provide a software implementation of a decryption algorithm for decrypting audio and/or video data when authorized. A set-top box, television, computer or other device then feeds encrypted data to the smart card 100 through the I/O module 120 and receives decrypted data in return, provided the smart card 100 determines that the device is authorized to receive this data. To this end, the memory 110 (or another memory) may store entitlement messages, licenses or rights objects, or the device may supply such items together with the data to which they apply.

As the workings of such systems are well-known, it will not be elaborated upon further. Smart cards are also useful in many other situations where security is desirable, as is known to the skilled person.

The software module 115 stored in the memory 110 is stored in an encrypted fashion. Any known or future encryption algorithm, for example AES or 3DES, can be used to encrypt this software module 115. This ensures that if an attacker manages to extract all or part of the contents of the memory 110, he does not obtain useful information on the software module 115. This module 115 may contain valuable know-how or cryptographic keys, e.g. authorization keys or decryption keys, that need to be protected.

The software module 115 is just one of the software modules stored in the memory 110. Other modules may be stored in the same memory 110 in encrypted or unencrypted (plaintext) form.

The smart card 100 provides a just-in-time decryption module 130 configured for decrypting the relevant portions of the software module 115 when they are to be executed by the processor 101. Possible implementations of the module 130 include a decryption of each instruction before it is fed to the processor 101, or decryption of blocks of the software module 115 that are then supplied as a whole to the processor 101. The decrypted instruction(s) or block(s) are erased from memory as soon as possible after execution.

In some embodiments of just-in-time decryption the decrypted instruction(s) or block(s) are stored in a temporary memory (not shown) in or near the processor 101. In such embodiments this temporary memory must be cleared when the instruction(s) or block(s) have been executed and when the smart card 100 is activated or deactivated.

Typically the just-in-time decryption functionality is implemented as a separate hardware module on the smart card 101, or as an embedded software module. The concept of just-in-time decryption, also known under names such as bus encryption, in smart cards is known as such from e.g. U.S. Pat. No. 4,168,396 or U.S. Pat. No. 5,224,166. The latter patent for example discloses a data processing system such as a smart card with an internal cache memory in a secure physical region of the system. An external memory, corresponding to memory 110, is positioned outside of the secure physical region and stores encrypted and non-encrypted data and/or instructions. An instruction enables access of a private key contained within the secure physical region which is used to decrypt an encrypted master key that accompanies encrypted data and instructions.

An interface circuit analogous to decryption module 130 in the secure physical region decrypts each encrypted master key through the use of the private key and also decrypts encrypted data and instructions associated with each decrypted master key. A central processor, corresponding to processor 101, accesses segments of both non-encrypted and encrypted data and instructions from the external memory and causes the interface circuit to employ a decrypted master key to decrypt data and instructions and to store the decrypted information in the internal memory cache. Non-encrypted data and instructions are directly stored in the internal memory cache.

In accordance with the present invention, the decryption functionality in module 130 is provided as a white-box implementation of the applicable cryptographic algorithm. As said, white-box implementations hide the inner workings of a cryptographic algorithm by using a combination of encoding tables in the cryptographic algorithm with random bijections representing compositions rather than individual steps.

International patent applications WO 2005/060147 (attorney docket PHNL031443), WO 2007/031894 (attorney docket PH001720) and WO 2006/046187 (attorney docket PHNL041207) disclose white-box implementations of cryptographic algorithms.

“White-Box Cryptography and an AES Implementation”, by Stanley Chow, Philip Eisen, Harold Johnson, and Paul C. Van Oorschot, in Selected Areas in Cryptography: 9th Annual International Workshop, SAC 2002, St. John's, Newfoundland, Canada, Aug. 15-16, 2002, referred to hereinafter as “Chow 1”, and “A White-Box DES Implementation for DRM Applications”, by Stanley Chow, Phil Eisen, Harold Johnson, and Paul C. van Oorschot, in Digital Rights Management: ACM CCS-9 Workshop, DRM 2002, Washington, D.C., USA, Nov. 18, 2002, referred to hereinafter as “Chow 2”, disclose methods of creating white-box implementations of cryptographic algorithms.

This provides that the decryption module 130 still operates as before and can decrypt those parts of the software module 115 stored in memory 110, but extracting any parts of the contents of the decryption module 130 does not provide any useful information on its workings, or on the decryption key used for decrypting parts of the software modules of memory 110.

While techniques exist (see the reference cited on page 1) to extract data fragments from smart cards, those techniques only reveal a small amount of data. For example, ISO standard 7816 prescribes that at most 255 bytes may leak from such an attack. Attacks such as a ROM extraction attack may expose more code, but because of the nature of such attacks typically 1 out of 5 bytes of data that are extracted have the incorrect value. This implies that an attacker can only have access to, on average, 80% of the white-box implementation, which is insufficient to recover any useful information from it.

Because the decryption mechanism implemented in module 130 is relatively small compared to the contents of memory 110, the storage requirements for this whitebox implementation are relatively small as well.

The small size of this mechanism also permits the use of more rigorous code security measures.

To reduce the storage requirements of the white-box implementation, an option is to use a cryptographic algorithm that uses 4-bit S-boxes instead of an algorithm like AES with 8-bit S-boxes, because an m-bit S-box results in a lookup table with 2^{m} rows. Another option, which can be used with or without the previous option, is to retain XOR operations in the algorithm as XOR operations instead of transforming these into tables.

In a preferred embodiment the decryption algorithm used is the Lombok cryptographic algorithm, as disclosed in U.S. Pat. No. 7,043,016 (attorney docket PHNL000365) and EP1307993B1 (attorney docket PHNL000444). More information on how to provide a white-box implementation of Lombok can be found in WO 2005/060147 (attorney docket PHNL031443). Lombok is very suited for a white-box implementation. Experiments have shown that a white-box implementation of Lombok can be as small as 10 kilobytes.

While the invention has been explained above with reference to one encrypted module 115, of course more than one software module can be stored in encrypted fashion and decrypted using the module 130.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In a device claim enumerating several means, several of these means can be embodied by one and the same item of hardware. The mere fact that certain measures are recited in mutually different dependent claims does not indicate that a combination of these measures cannot be used to advantage.

1. A method for securing a smart card, the method comprising:
accessing the smart card, the smart card comprising a processor, a memory for storing in an encrypted fashion a software module to be executed by the processor, and a decryption module configured for just-in-time decryption of the software module; and
providing the smart card with a white-box implementation of the decryption module.

2. The method of claim 1, comprising using the decryption module to implement a cryptographic algorithm with S-boxes that map 4 bits to 4 bits.

3. The method of claim 1, in which the white-box implementation retains any XOR operations in the cryptographic algorithm used for the decryption module instead of transforming said XOR operations into table lookups.

4. The method of claim 1, in which the white-box implementation comprises a white-box implementation of a Lombok cryptographic algorithm.

5. A smart card comprising:
a processor;
a memory configured for storing in an encrypted fashion a software module to be executed by the processor; and
a white-box implementation of a decryption module configured for just-in-time decryption of the software module.

6. The smart card of claim 5, wherein the decryption module comprises a cryptographic module including S-boxes that map 4 bits to 4 bits.

7. The smart card of claim 5, in which the white-box implementation of the decryption module is configured to retain any XOR operations in the cryptographic module used for the decryption module instead of transforming said XOR operations into table lookups.

8. The smart card of claim 5, in which the white-box implementation comprises a white-box implementation of a Lombok cryptographic algorithm.

9. The method of claim 1, wherein the processor comprises a processing means 101.

10. The method of claim 1, wherein the decryption module comprises a decryption means 130 for just-in-time decryption of the software module.
